(19) United States
(12) Patent Application Publication
(10) Pub. No.: US 2020/0042741 A1
(43) Pub. Date: Feb. 6, 2020

(54) INFORMATION PROCESSING APPARATUS, SECOND INFORMATION PROCESSING APPARATUS, SYSTEM, METHOD AND COMPUTER PROGRAM PRODUCT

(71) Applicant: Sony Corporation, Tokyo (JP)

(72) Inventor: Renaud DIFRANCESCO, London (GB)

(73) Assignee: Sony Corporation, Tokyo (JP)

(21) Appl. No.: 16/080,551

(22) PCT Filed: Mar. 6, 2017
(86) PCT No.: PCT/GB2017/050588

§ 371 Date: Aug. 28, 2018

(30) Foreign Application Priority Data
Mar. 23, 2016 (GB) 1604904.1

(51) Int. Cl. G06F 21/62; H04L 29/06

(52) U.S. Cl. CPC G06F 21/6254; H04L 63/08; H04L 63/0421

(57) ABSTRACT

A method of obfuscating information communicated between a first apparatus and a second apparatus, comprising: in the first apparatus, obtaining genuine information to be communicated to the second apparatus; obtaining decoy information to be communicated to the second apparatus; indicating the decoy information to be communicated to the second apparatus; transmitting the genuine information to the second apparatus; and periodically transmitting the decoy information to the second apparatus; in the second apparatus, receiving the genuine information and the decoy information from the first apparatus; identifying the decoy information; and acting on the genuine information and isolate the decoy information.

### BACKGROUND

### Field of Disclosure

The present disclosure relates to an information processing apparatus, second information processing apparatus, system, method and computer program product.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Many consumers demand that devices now communicate with one another wirelessly. These devices include even devices not previously requiring connectivity. For example, some devices in the home such as plug sockets can be part of a larger so-called “connected home” where the plug sockets can be controlled by devices either within the home or remotely. In order to do this, these connected devices need to communicate regularly with one another.

As these devices are wirelessly connected to one another they are prone to snooping. In other words, an adversary may sit outside the home containing the connected device and intercept data which would identify movements of the user of the home. For example, if an adversary identifies that a connected light is switched on at 16:00 every day by intercepting a switch on signal from the connected light, and then one day the light is not switched on, then the adversary will know that the user is not at home and may enter the house unlawfully.

In another scenario, a user wearing a health monitoring system may have their personal health information intercepted.

It is an aim of the present disclosure to at least address one of these problems.

### SUMMARY OF THE DISCLOSURE

According to one embodiment of the disclosure there is provided, a method of obfuscating information communicated between a first apparatus and a second apparatus, comprising: in the first apparatus, obtaining genuine information to be communicated to the second apparatus; obtaining decoy information to be communicated to the second apparatus; indicating the decoy information to be communicated to the second apparatus; transmitting the genuine information to the second apparatus; and periodically transmitting the decoy information to the second apparatus; in the second apparatus, receiving the genuine information and the decoy information from the first apparatus; identifying the decoy information; and acting on the genuine information and isolate the decoy information.

Further respective aspects and features are defined by the appended claims

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 shows a diagram of a system according to the present disclosure;

FIG. 2 shows a block diagram of an information processing apparatus according to the present disclosure;

FIG. 3 shows a flow chart explaining the set-up operation for embodiments of the disclosure;

FIG. 4 shows a flow chart explaining the operation of an information processing apparatus according to embodiments of the present disclosure; and

FIG. 5 shows a flow chart explaining the operation of a second (other) information processing apparatus according to embodiments of the present disclosure.

### DETAILED DESCRIPTION OF THE EMBODIMENTS

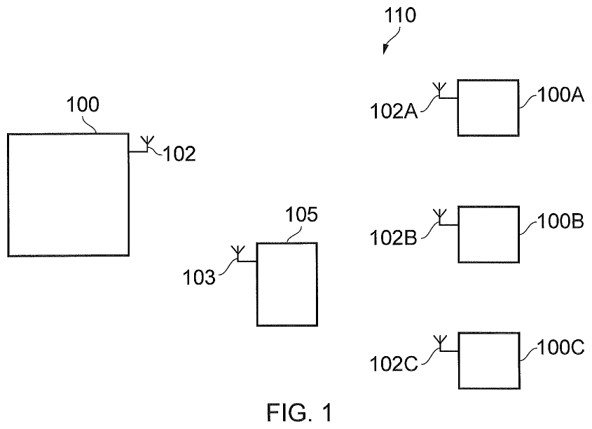

FIG. 1 shows a system 110 according to the present disclosure. The system 110 includes one or more information processing apparatus 100. The information processing apparatus 100 communicates wirelessly in the system using antenna 102. Within the system, a hub 105 is provided. The hub includes hub antenna 103. The information processing apparatus 100 may communicate with one or more other information processing apparatuses 100A-100C directly in a peer to peer type arrangement or may communicate with the other information processing apparatuses via hub 105. In embodiments the hub may be local (for example located in same building) as apparatus 100 or distant (e.g. up to hundreds of kilometres away, the disclosure is not limited to any particular distance. In other words, the hub 105 may act as a relay between information processing apparatus 100 and the other information processing apparatuses 100A-100C. Moreover, hub 105 may be connected to the Internet and may act as a repository for information about each of the information processing apparatuses in the network 110. This repository may be stored locally on the hub or the over the internet and on the cloud or a distributed cloud network. As such the hub may in embodiments contain electronic memory. An example of the hub is the Sony Xperia Agent. Further, an example of information processing apparatus 100 is a television with Internet of Things (IoT) functionality. The other information processing apparatuses may include a fridge in information processing apparatus 100A. The fridge is an example of a food storage receptacle. Other examples of food storage receptacles include a food storage cupboard, a larder or a freezer. A further example of an information processing apparatus 100B is a smart light. A smart light is an IoT capable device that can be controlled over a network remotely. A third example of an information processing apparatus 100C is a curtain controller which is an IoT enabled device which allows the curtains to be opened and closed using commands received remotely. The other information processing apparatuses 100A-100C communicate with either the hub 105 or the information processing apparatus 100 directly using respective antennas 102A-102C. In a general sense, information processing apparatus 100 may comprise a sensor for one specific condition, or for multiple conditions, for example water or other liquid level or throughput, position, temperature, velocity or acceleration, atmospheric condition, presence or any status or measurement, etc. The information processing apparatus may contain a camera or image sensor which monitors a scene and further contains circuitry which image statistic information or feature data about colour, luminance, motion or other properties of a scene. This can in embodiments reduce the need to transfer video data in its entirety via a communications channel. Such data may include anomaly data which represents changes from a normal condition or scene that the camera or image sensor is directed to. This could for example include a security threat such as a suitcase left in a public place, detection of rodents or other infestation, or detection of changes to plants in the natural environment or in the field of indoor or outdoor agriculture such as wilting or disease on a leaf, cell growth optionally on a sample holder in the field of medical diagnostics.

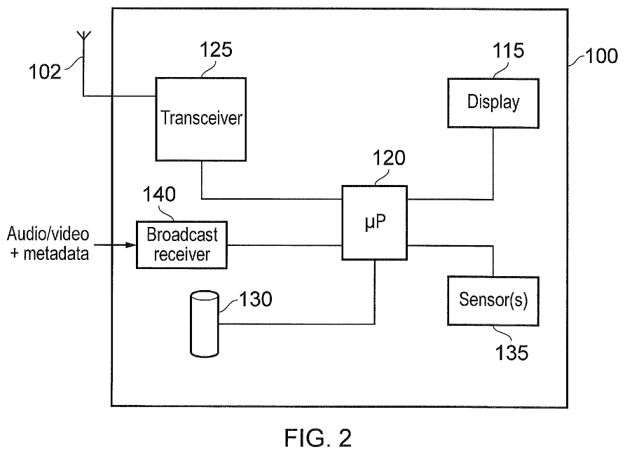

Referring to FIG. 2, a block diagram of information processing apparatus 100 is shown. The antenna 102 is connected to transceiver circuitry 125. The transceiver circuitry 125 contains either a transmitter or a receiver or both a transmitter and receiver. The purpose of the transceiver circuitry 125 is to communicate data over the system 110 using antenna 102. This communication may be done using WiFi, Bluetooth, or the like.

The transceiver circuitry 125 is connected to controller circuitry 120. The controller circuitry 120 is a microprocessor type device whose functions and operations are controlled by software. Of course, the control circuitry 120 may be a Field Programmable Gate Array (FGPA), Application Specific Integrated Circuit (ASIC) or another type of hard wired control unit.

Also connected to the control circuitry 120 is storage 130. The storage may be a magnetically readable storage medium or a solid state storage medium. The storage medium, in this case, contains the software code which is used to control the control circuitry 120. Additionally, the storage 130 is used to store parameters defined either by the user or at manufacture in association with metadata received by the information processing apparatus 100. This will be explained later.

In embodiments of the disclosure, the information processing apparatus 100 is a smart television. Therefore, a broadcast receiver 140 is provided that receives audio and/or video multimedia data. This is broadcast data that includes metadata. The broadcast audio and/or video data may be sent for example using the digital video broadcast (DVB) standard which has provision to include metadata along with the content. The broadcast receiver 140 is connected to the control circuitry 120. The broadcast receiver 140 is configured to provide to the control circuitry 120 the received audio and/or video material and the metadata sent in association with the multimedia data.

A display 115 is also provided in information processing apparatus 100. This display is connected to the control circuitry 120. The display may be a touchscreen display that allows the user to interact with the information processing apparatus 100 by touch using either their finger or a touching object.

Alternatively, the display 115 may not include a touchscreen. In this case, a user will be provided with a different mechanism by which to interact with the television such as a mouse, remote commander or the like. An application running on a smartphone or tablet computer and in communication with the television is also envisaged.

Additionally connected to the control circuitry 120 is one or more sensor 135. The sensor 135 may include an accelerometer, gyroscope, GPS device or the like. The function of the sensor is to measure a physical parameter of the information processing apparatus 100 such as tilt or rotation or geographical position.

Embodiments of the present disclosure will now be described with reference to various use cases.

Operation of the System

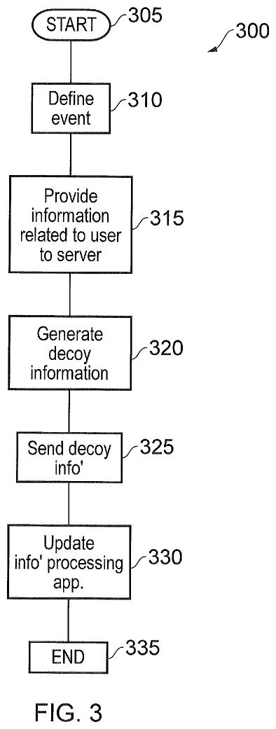

FIG. 3 shows a flow chart 300 describing the set up operation of the system according to embodiments.

The process starts in step 305. In step 310, an event related to the user is defined. The event is, in embodiments, a situation in which information relating to the user may be divulged. For example, the information relating to the user may divulge whether a user is present in the location or information pertaining to the user's health or the like.

The information processing apparatus 100 stores the event in a list of events. An example of the list is shown in table 1 below. In the example below, the events are associated with a smart television.

TABLE 1
Event Table

| EVENT | TIME | Frequency |
|---|---|---|
| Switch on | 1) 16:00; 2) 18:35 | 1) Every day; 2) Every day |
| Switch off | 1) 16:35; 2) 22:00 | 1) Every day; 2) Every day |
| Channel | 1) BBC 1; 2) ITV1 | 1) Every day; 2) Every day |
| Record | 1) No: 2) Yes | 1) once a month; 2) once a week |

In table 1, there is shown four predefined events associated with a smart television. Specifically, the smart television may wirelessly communicate with other network connected devices when it is switched on, switched off, which channel is currently being viewed and whether that channel is being recorded. Of course, other alternative or additional events may be defined in table 1; these four events are merely illustrative. Additionally, the times at which these events take place is noted in table 1. In table 1, the smart television is switched on at 16:00 and switched off at 16:35. During this watching event, BBC1 is being watched and the channel is not recorded. The smart television is switched on again at 18:35 and switched off at 22:00. During this time, ITV1 is viewed and this channel is recorded.

In the column entitled “Frequency”, the frequency of each event is stored. In this column, it is seen that the user watches these channels on the smart television every day during the same time period. However, only once a month does the user not record BBC1 during the first period of viewing and the user records ITV1 once a week during the second period of viewing.

These events, including switch on and switch off times, channel and record status, may be automatically collated during a period of learning or may be configured by the user during the set-up routine. In the event that the smart television automatically collates the information, the frequency of each event may also be determined. It is expected that any period of learning would be over an extended period of time, such as a month, so that the user's habits may be learned. This period of learning may be shortened by the user answering a questionnaire during setup to learn more of the user's habits and working patterns.

The purpose of the information in table 1 is to establish a routine of the user's habits. By capturing the habitual information relating to the user of the smart television associated with an event (for example, what time does the user switch on the television, and how often is the television switched on at that time), it is possible to establish what information an eavesdropper intercepting that information will obtain and importantly, what information they expect to obtain at that time. This is important because if the eavesdropper does not receive that information at that time, then the eavesdropper will know that there is a change in the user's routine (for example, the user is out, i.e. not present at the premises) and may use this information for nefarious purposes.

Step 310 defines the user's habits in respect of one information processing apparatus (in this case, a smart television). However, the user's habits in respect of every connected device will be set. In embodiments, the information in table 1 is stored in the smart television. However, it is anticipated that the information in table 1 will be stored in a server located on a network. The information is provided to the server in step 315. Within the server will be stored the habits of many other users and many other devices.

An example of a table within the server is provided in table 2 below.

TABLE 2
Table at Server

| EVENT | TIME | Frequency |
|---|---|---|
| Switch | User A: 1) 16:00; 2) 18:35 | User A: 1) Every day; 2) Every |
| on | | day |
| | User B: 1) 15:00; 2) 19:40 | User B: 1) Once a week; 2) |
| | | Every day |
| | UserC: 1) 17:15; 2) 20:20 | User B: 1) Every day; 2) Once |
| | | a week |
| Switch | User A: 1) 16:35; 2) 22:00 | User A: 1) Every day; 2) Every |
| off | | day |
| | User B: 1) 15:20; 2) 22:15 | User B: 1) Once a month; 2) |
| | | Once a week |
| | UserC: 1) 19:30; 2) 23:15 | User C: 1) Every day; 2) Once |
| | | a fortnight |
| Channel | User A: 1) BBC 1; 2) ITV1 | User A: 1) Every day; 2) Every |
| | | day |
| | User B: 1) SKY1; 2) NickJr | User B: 1) Every day; 2) Every |
| | | day |
| | User C: 1) Gold; 2) | User C: 1) Every day; 2) Every |
| | SKY SPORTS1 | day |
| Record | User A: 1) No; 2) Yes | User A: 1) once a month; 2) |
| | | once a week |
| | User B: 1) No; 2) No | User B: 1) Every day; 2) Every |
| | | day |
| | UserC: 1) Yes; 2) No | User C: 1) Every day; 2) Every |
| | | day |

In table 2, there are provided the habits of the user of table 1 (user A) and two other users (user B and user C). These habits are all of the same type of information processing apparatus (a smart television). The users may be of a similar demographic or live in a similar area. In other words, the three users have similar, but not the same, viewing habits.

In embodiments of the disclosure, the table at the server is used to produce decoy event information which is stored in the information processing apparatus and which is communicated by the information processing apparatus instead of the genuine information.

In embodiments of the present disclosure, the decoy information is selected by randomly selecting one additional event from table 2. For example, the switch on information of user B and the switch off information of user C may be selected. Further, the channel profile of user B and the record profile of user C may be used. In embodiments, the randomly selected profiles are compared with the profile of user A to ensure that the selections are appropriate. For example, the channel profile of user B will need to be compatible with those of user A in order to be realistic (i.e. if user A cannot receive the channels of the user B profile, then this is an inappropriate selection). Further the switch on and switch off times need to be appropriate so that the switch off time is chronologically after the switch on time.

This generation of the decoy information takes place in step 320. The decoy information is sent to the information processing apparatus in step 325. Table 1 in the information processing apparatus is updated in step 330. Therefore, table 1 including the decoy information is provided in table 3, below.

TABLE 3
User habit information including decoy data stored
at the information processing apparatus

| EVENT | TIME | Frequency |
|---|---|---|
| Switch | Genuine: 1) 16:00; 2) 18:35 | Genuine: 1) Everyday; 2) |
| on | | Every day |
| | Decoy: 1) 15:00; 2) 19:40 | Decoy: 1) Once a week; 2) |
| | | Every day |
| Switch | Genuine: 1) 16:35; 2) 22:00 | Genuine: 1) Everyday; 2) |
| off | | Every day |
| | Decoy: 1) 19:30; 2) 23:15 | Decoy: 1) Every day; 2) |
| | | Once a fortnight |
| Channel | Genuine: 1) BBC 1; 2) ITV1 | Genuine: 1) Everyday; 2) |
| | | Every day |
| | Decoy: 1) SKY1; 2) NickJr | Decoy: 1) Every day; 2) |
| | | Every day |
| Record | Genuine: 1) No: 2) Yes | Genuine: 1) once a month; 2) |
| | | once a week |
| | Decoy: 1) Yes; 2) No | Decoy: 1) Every day; 2) |
| | | Every day |

This table may be shared with other devices connected to the information processing apparatus 100. In embodiments, this is shared over a secure channel or may be encrypted before sending. This enables the other information processing apparatuses to know if a particular communication it receives from the information processing apparatus is a decoy or genuine event. So, for example, if another information processing apparatus receives a switch on signal from the information processing apparatus at 19:40, the other information processing apparatus knows it is a decoy signal and will be ignored. However, if the other information processing apparatus receives a switch on signal at 15:00, the other information processing apparatus knows that this is a genuine signal.

It is not necessary to send the decoy data in a table such as that in table 3. Instead, it is possible to identify the decoy data with a flag. The flag may comprise one or more bits of data. The flag may be in a predetermined or detectable position relative to the decoy data (for example when unencrypted). The flag may be, for example, sent as an encrypted packet on a clear channel. Alternatively, decoy data may be sent with a higher signal power than the genuine data. These are only examples of distinguishing the decoy data from the genuine data and any mechanism is envisaged. In some embodiments a small amount of data that is not realistic, i.e. receipt of a TV channel that is not possible in a particular location, an unlikely temperature reading, or the like could serve as an identifier for decoy data.

The process ends at step 335.

Some embodiments of the disclosure may aim to increase the likelihood of inserting decoy data that is more plausible. This prevents the eavesdropper from filtering out the decoy data or at least makes their task more difficult. One approach is, as in the preceding description to develop over time a user history. In embodiments this may include receiving from and optionally selecting from the events of other users. The history may be partitioned into discrete portions of time, for example 24 hours portioned into one hour portions. Individual days of the week or weekends or weekdays or public holidays or periods when the user is on vacation or works irregular hours or is otherwise absent may be partitioned into portions the same or differently and be defined in the history. Decoy information may be selected from corresponding portions in time, for example, there may be a history in a portion from 10 am to 11 am on a weekday. Only events from that portion of the history may be inserted as decoy data at that time of day. This makes the decoy data more plausible. The portion of history may be different at weekends, so on a weekday the portion of history for weekdays only may be used Similar rules may apply as mentioned for individual days of the week, public holidays etc. It may be that for some demographics of users, the chance of an event occurring within a particular portion of history is the same whether it is a weekday or weekend. In such a case the decoy information may be selected without reference to whether it is a weekday or a weekend day.

Similarly rather than (or in addition to) applying temporal threshold to history to select decoy information, a location-based or spatial portioning of a candidate plausible decoy events may be used. For example, if another user's history is used to provide plausible decoy information, then it should be selected from correspondingly plausible other users. So in a country with wide temperature variations then inserting decoy information indicating that the thermostat in a room has been set to a very high temperature would be implausible as decoy information for a user where the outside temperature is very low. Therefore a subset of users from which to base decoy information is defined according to their spatial whereabouts. A subset of users is defined from which to select suitable decoy information based on an information parameter or attribute data. That information parameter may be a location or demographic. Of course, the foregoing has been described with respect to user, but more generally it applies to any article or service to which genuine information pertains, such as a vehicle, logistics container, energy or data consumed or waste product produced (e.g. CO2, waste water).

The decoy data may be derived from genuine data, for example copied at least in part from genuine data generated at another time by the same apparatus or by another similar apparatus generating genuine data or by simulating a similar apparatus.

The above explains how the decoy data is generated and shared. The following explains various use cases for the decoy data.

Use Case 1—Vacant Home

Homes that are left vacant for a period of time, such as when occupants are on holiday, have different electricity usage requirements as devices are not activated. Therefore, in the case that devices communicate around a home network, the usage patterns can be collected by an eavesdropper. So, any changes in these usage patterns will be identified and may be used by the eavesdropper to determine whether the user is at home. While the eavesdropper may not be able to determine the actual data sent because it is encrypted or sent over a secure channel, the pattern of sending the data for example its periodicity, the relative time at which it is sent or more generally its context may provide some information to the eavesdropper that can be put to unintended or nefarious uses. The pattern of data may therefore unintentionally provide contextual information about the user such as whether they are at home or the like.

By sending decoy information, the genuine usage patterns of the user will be obfuscated. For example, the usage patterns detected by an eavesdropper will contain genuine information and decoy information.

Therefore, the eavesdropper will not know which information is genuine and which information is a decoy. However, as the network will know which data is genuine and which data is decoy data, the network will be able to ignore or otherwise isolate the decoy information.

By providing the decoy information, therefore, the genuine event information related to the user will be obfuscated.

Use Case 2—Health Information

With medical devices being connected together, an eavesdropper may obtain health information associated with a patient. In other words, if a device is measuring health related information of a patient (the user in this case), this information may be intercepted by an eavesdropper and used scurrilously.

In this case, the genuine information may be obfuscated by providing decoy data such as alternative readings of the health information derived from other patients. For example, other values of blood pressure, heart rate or the like may be provided. In this case, the medical device receiving the information may determine whether the information is decoy data by comparing the received measurements with known medical traits of the patient. For example, if the device is measuring blood pressure, if the medical device knows that the patient has a history of high blood pressure, the decoy data could be very low blood pressure readings. Given this comparison of the received information with the known medical history of the patient, the decoy data can be identified easily.

In addition to the eavesdropper scenario, in some instances, insurance companies may request health information about a patient. However, sometimes, the insurance companies are entitled to some information (relating to, say, family history) but are not entitled to other information, such as blood pressure. In this case, the blood pressure information may be obfuscated by providing decoy data relating to blood pressure. In this case, the blood pressure information may be randomly selected and anonymised data from other patients. It is envisaged that the blood pressure information will not be deceptive, so only blood pressure data within medically safe parameters will be selected.

Of course, although the above mentions blood pressure, heart rate, respiratory statistics or measurements, temperature and the like, the disclosure is not so limited and any kind of health-related parameter is envisaged.

Use Case 3—Broadband Usage

With numerous devices offering Internet connectivity, an eavesdropper may obtain Internet usage information from a device. This may be used scurrilously by an eavesdropper. This is especially the case if the user of the connected device access content from a legal, but vice-like webpage, such as a gambling or pornography website. In this case, decoy Internet usage information may be provided to obfuscate the genuine information. For example, the decoy information may include pornography or gambling website information. This means that the eavesdropper will not know whether the user genuinely accessed pornography or a gambling website, or whether the information is decoy information.

Of course, although the above refers to obfuscating website information, the disclosure is not so limited. In fact, any kind of broadband usage, wired or wireless may be obfuscated.

In embodiments, communications regarding broadband usage or metering between a home gateway or connected device and the local exchange or a local or regional billing server could be obfuscated. Similarly communication between a utility smart meter and a local or regional server could be obfuscated. Decoy data could be selected from other users' genuine data. The other users' information which provides a subset of genuine data to select from as the decoy data may be limited to data communicated to the particular local/regional server to make the plausibility of the decoy data more realistic.

Use Case 4—Connected Car

As connected cars (that is, cars that communicate with other devices) become increasingly common, an eavesdropper may obtain route information relating to the user's journey from the car. If the eavesdropper has wicked intentions, they may identify the ultimate location of the user or stopping points along the journey. In this case, the eavesdropper may ambush the user in the vehicle when stationary. Typical opportunities may exist if the eavesdropper obtains the final destination or information relating to the fuel consumption and range of the vehicle, or the overall length of the journey. As an example, the eavesdropper may know the route of the car and may intercept the user in their vehicle at a fuel stop or a rest stop, in addition to the final destination.

In this case, the decoy data may include a range of travel that exceeds the range of the fuel tank. Alternatively, the decoy data may include a false destination. If the destination is a favourite of the user, then in order to determine whether the destination information is decoy information, the device receiving the information may compare the destination information with the favourites. In the event that the destination information is a favourite, then the information is genuine, whereas if the destination information is not a favourite, then the information is decoy information.

Of course, other information relating to the car may be obfuscated. For example, vehicle and passenger information, vehicle entertainment choices, and other sensor information or the like may need to be obfuscated.

Use Case 5—Logistics

It is envisaged that in logistics, connected devices will play an important role. For example, it is possible for the logistics container to contain a device that informs other devices of the contents of the container and its destination. In this instance, an eavesdropper may wish to identify the contents of the container and to intercept the container at an opportune moment. For example, the eavesdropper may identify a container having a high value contents and may intercept the container at an opportune moment. This may be decided on the basis of the route information. Therefore, in the context of logistics, it is useful to obfuscate the content information and the route information.

This obfuscation may be achieved by providing different contents which are incompatible with the type of container. For example, the decoy content may be contents that require freezing if the container is not a container having such freezing functionality. In this case, the legitimate receiving device knows that the container does not have such functionality and so can identify the decoy information.

Use Case 6—Shop Stock

It is envisaged that in the retail environment, connected devices will play an important role especially in monitoring stock and providing offers and information about products to the consumer. For example, as a user considers purchasing a product, the display on which the product is provided may provide latest offer information to the consumer's connected device. Additionally, it is envisaged that as products are purchased, the stock level within the store will automatically updated. This provides real time stock levels of products within the store. It is possible that an eavesdropper may obtain the stock level information and use this information to monitor the sales statistics associated with a competing product. As an example, the manufacturer of product A may monitor sales of product B manufactured by a competitor. This information may be scurrilously used to adjust offers in a store or even change the purchasing arrangements between the manufacturer and the store. It is therefore useful to obfuscate the stock level and latest offer information.

This obfuscation may be achieved by providing a link to a database for the stock level information and the offers information. It is envisaged that access to the database will be provided via a secure mechanism. Specifically, but not exclusively, the connected device would register with the database before access is provided. In order for stock levels to be provided, the connected device would need to be a connected device associated with the shop (for example, a connected device used by a shop member of staff). In order for offers to be provided, the connected device of the consumer would need to be linked to a loyalty scheme or to a unique identifier belonging to a consumer. The obfuscated information would be an identifier uniquely identifying the address of the relevant stock level or offer. Without the access to the database, the connected device would not receive the stock level or offer information. Indeed, using this technique may also allow different offers to be provided to different users. For example, if the connected device is linked to a particular loyalty scheme, the shopping habits of the user may be used to select the relevant offer. The identifier to the relevant offer may be sent to the connected device. This allows a single database to be used to store several offers which may be applied to a product. This eases database administration.

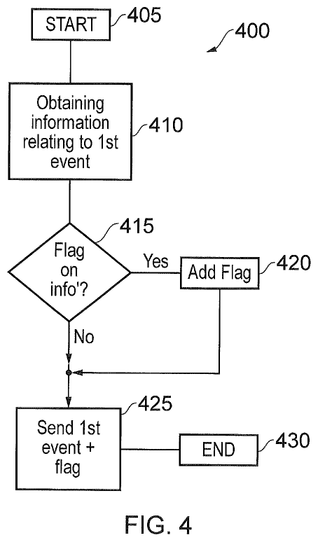

Referring to FIG. 4, a flow chart 400 explaining the process within an information processing apparatus is shown. The process starts at step 405. The process moves to step 410 where the information relating to the first event is identified. In embodiments of the disclosure described with reference to table 1, this is the information associated with switch on, for example, such as the time of switch on.

The information processing apparatus 100 then determines whether the information is genuine information or decoy information. In embodiments, if the information is genuine information then no flag is required and the process moves to step 425. Alternatively, if the information is decoy information, then the flag is set in step 420 and the process then moves to step 425. In embodiments, the flag may be sent in encrypted form, or over a secure channel or the like. Of course, no flag may be required. As explained above, the decoy information may be mutually exclusive to the genuine information. In this case, no flag is required as the second information processing device knows that the information is decoy information. Further, if table 3 explained above is provided to the other information processing apparatus, then no flag is required as the other information processing apparatus knows whether the information is decoy information or genuine information. Mutually exclusive does not necessarily mean in invalid, such as by use of illegal, unexpected or unrecognisable characters in the decoy information. Mutually exclusive decoy information should be interpretable as a plausible scenario, but recognisable as impossible in a series of events or at least highly improbable. A processor may apply a threshold to determine a suitably improbable scenario. A further example relating to the smart TV scenarios already discussed might be that a receiver is factory set to wake up (from a standby state) once a day at 10 am to check for updates or updated EPG information. Mutually exclusive decoy information may be to have the wake up occur when another event is scheduled or at a time other than 10 am or multiple numbers of times per day when the factory settings of the receiver are such that the wake up can occur only once.

The information processing apparatus then sends the first information (and optionally the flag) in step 425 to the other information processing apparatus and the process ends in step 430.

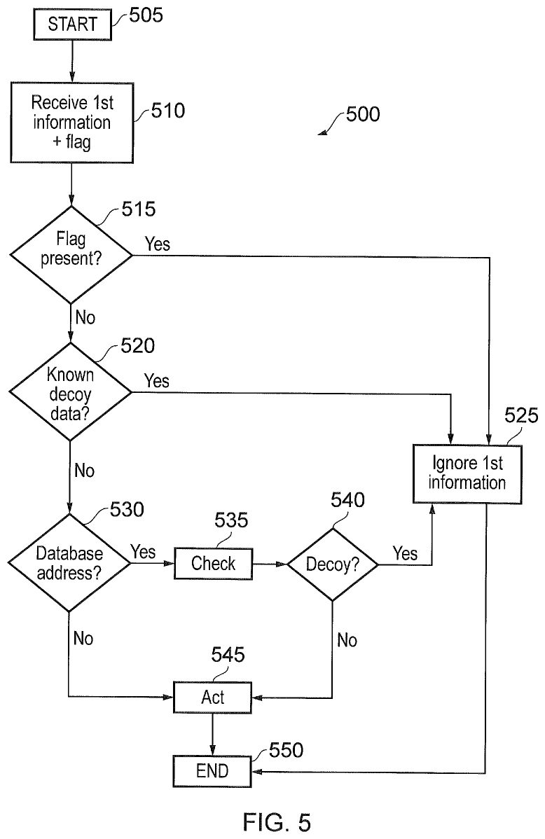

Referring to FIG. 5 a flow chart 500 at the other information processing apparatus is disclosed. The process starts at step 505. The other processing apparatus receives the first information and optionally the flag in step 510. The other information processing apparatus then checks to identify if a flag is present in step 515. If no flag is present, the process moves to step 520.

Alternatively, if a flag is present, the process moves to step 525 and as the other information processing apparatus knows that the first information is decoy data, the information is ignored. The process then moves to step 550 and ends.

In the event that the process moved to step 520, the other information processing apparatus checks to see if the information is known decoy data. This is achieved by checking the copy of table 3 held within the other information processing apparatus. If the information is decoy data, the process moves to step 525 and the information is ignored.

Alternatively, if the information is not known decoy data, the “no” path is followed and the process moves to step 530.

In the event that the process moves to step 530, the other information processing apparatus checks to see if the information is a database address. This is achieved by checking the format of the data, for example. If the information is a database address that uniquely identifies the location of the data, the process moves to step 535 where the database address is attempted to be accessed by the other information processing apparatus. This may involve the other information processing apparatus providing authentication information to the database to allow access to the database. If the authentication information is not provided, access will not be provided and so the process will end. However, if authentication information is provided, the other information processing apparatus will be given access to the unique address within the database. The address within the database will be checked and it will be determined whether the information stored at the address is decoy information in step 540.

If the information is decoy information, the “yes” path is followed and the information will be ignored in step 525. However, if the information at the address within the database is not decoy information, the process moves to step 545.

Returning to step 530, in the event that the information is not a database address, the no path is followed and the process moves to step 545.

In step 545, the other information processing apparatus will act on the information provided. For example, in the case of the retail information, the other information processing apparatus will appreciate that the information is not decoy information and will provide a stock level or appropriate offer to the other information processing apparatus.

The process will then end at step 550. Similarly, if the information provided to the other information processing apparatus is decoy information, the process will move to step 550 and the process will end.

In some embodiments, when intrusions into systems such as the use cases described above are detected by the information processing apparatus 100 or detected by the networks to which they are detected and that intrusion is based on the known decoy information that has been transmitted, then those information processing systems can report the intrusion to server in order that appropriate action can be taken to patch the vulnerability. In embodiments, the detection of the intrusion may cause an instruction to the information processing apparatus to shut down, or otherwise reduce its capabilities. For example if, based on decoy information that a vehicle was in motion when in fact it was stationary, the eavesdropper put the decoy information to use to apply the brakes to cause an intentional accident, then the vehicle could be appropriately immobilised pending repair of the security vulnerability. The shut down or disablement could be immediate or await a safe condition such a reaching a safe location before enabling the shut down or disablement.

Embodiments have been described with respect to wireless devices and networks. The disclosure is not so limited. The disclosure may be applicable to devices connected by wired network such as Ethernet. Devices may require mains electrical power. The mains electrical power may also provide via electrical circuits the network capability for the device such as via PowerLine Communications (PLC) interfaces. The disclosure may prove useful where a user does not have sole control or access over the wired network or mains electrical circuits such as in a shared building. As such, decoy information may be sent over the wired network or mains electrical network. In embodiments, a household having a number of electrical devices may generate an electrical load signature from washing machine, fridge, battery chargers, etc. This may be different when the home is vacant. Decoy information may be used to maintain the usual electrical load signature to prevent an eavesdropper detecting that the home is vacant. Such decoy information or resultant electrical load may be isolated at the electrical meter or by the energy provider and compensated for.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the disclosure may generally be described by reference to the following paragraphs.

1. A method of obfuscating information communicated between a first apparatus and a second apparatus, comprising:
in the first apparatus,
   obtaining genuine information to be communicated to the second apparatus;
   obtaining decoy information to be communicated to the second apparatus;
   indicating the decoy information to be communicated to the second apparatus;
   transmitting the genuine information to the second apparatus; and
   periodically transmitting the decoy information to the second apparatus, wherein the decoy information is selected based on the time of transmission of the decoy information and/or the location of the first apparatus;
in the second apparatus,
   receiving the genuine information and the decoy information from the first apparatus;
   identifying the decoy information; and
   acting on the genuine information and isolate the decoy information.

2. A method according to paragraph 1, comprising, in the first apparatus, indicating the decoy information by application of a flag to the decoy information.

3. A method according to paragraph 1 or 2, wherein the genuine information and the decoy information are database addresses and, in the second apparatus, the identifying step comprises, accessing the database address to identify decoy information.

4. A method according to paragraph 3, comprising, in the second apparatus, providing authentication information to the database prior to accessing the database address, wherein in the event of a failed authentication, the second apparatus isolates the information.

5. A method according to any preceding paragraph, wherein the genuine information is mutually exclusive to the decoy information.

6. A method according to any preceding paragraph, wherein the decoy information at the time of transmission is selected from genuine information obtained at that same time on a different day.

7. A method according to preceding paragraph, wherein the genuine information relates to a user of the first apparatus.

8. A method according to paragraph 7, wherein the genuine information relates to the presence of a user at a location.

9. A method according to paragraph 7, wherein the decoy information is selected from a store of genuine information associated with other users of different apparatuses.

10. A method according to paragraph 9, wherein the other users are demographically similar to the user of the first apparatus.

11. A method according to paragraph 9, wherein the other users are located in a similar geographical location to the user of the first apparatus.

12. A method according to one of paragraph 7 to 11, wherein the genuine information is information relating to the health of the user of the first apparatus.

13. A method according to one of paragraph 7 to 12, wherein the genuine information is information relating to the internet usage of the user of the first apparatus.

14. A method according to one of paragraph 7 to 13, wherein the genuine information is information related to a journey being conducted by the user of the first apparatus.

15. A method according to paragraph 14, wherein the genuine information is route information or information relating to a characteristic of the vehicle in which the user is travelling.

16. A method according to any preceding paragraph, wherein the genuine information is content information relating to the contents of a logistic container.

17. A method according to preceding paragraph, wherein the genuine information is information relating to a good in a shop.

18. A method according to paragraph 17, wherein the information is offer information.

19. A method according to any preceding paragraph, wherein the information is communicated wirelessly between the first apparatus and the second apparatus.

20. A method according to any preceding paragraph, wherein the decoy information is communicated to the second apparatus in place of the genuine information.

21. A method according to any preceding paragraph, wherein the decoy information is ignored within the second apparatus.

22. A method of receiving obfuscated information communicated from a first apparatus, comprising:
receiving genuine information and, periodically, decoy information, wherein the decoy information is selected based on the time of transmission of the decoy information and/or the location of the first apparatus;
identifying the decoy information; and
acting on the genuine information and isolating the decoy information.

23. A method of transmitting obfuscated information to a second apparatus, comprising:
obtaining genuine information to be communicated to the second apparatus;
obtaining decoy information to be communicated to the second apparatus;
indicating the decoy information to be communicated to the second apparatus;
transmitting the genuine information to the second apparatus; and
periodically transmitting the decoy information to the second apparatus, wherein the decoy information is selected based on the time of transmission of the decoy information and/or the location of the first apparatus.

24. A computer program product comprising computer readable instructions which, when loaded onto a computer, configures the computer to perform a method according to any preceding paragraph.

25. An information processing apparatus, comprising:
communication circuitry configured to communicate with a second information processing apparatus; and control circuitry configured to:
obtain genuine information to be communicated to the second information processing apparatus;
obtain decoy information to be communicated to the second information processing apparatus;
indicate the decoy information to be communicated to the second information processing apparatus;
transmit, via the communication circuitry, the genuine information to the second information processing apparatus; and
periodically transmit, via the communication circuitry, the decoy information to the second information processing apparatus, wherein the decoy information is selected based on the time of transmission of the decoy information and/or the location of the first apparatus.

26. An information processing apparatus according to paragraph 25, wherein the control circuitry is configured to indicate the decoy information by application of a flag to the decoy information.

27. An information processing apparatus according to paragraph 264, wherein the genuine information and the decoy information are database addresses.

28. An information processing apparatus according to any one of paragraph 25 to 27, wherein the genuine information is mutually exclusive to the decoy information.

29. An information processing apparatus according to any one of paragraphs 25 to 28, wherein the decoy information at the time of transmission is selected from genuine information obtained at that same time on a different day.

30. An information processing apparatus according to any one of paragraph 25 to 29, wherein the genuine information relates to a user of the first apparatus.

31. An information processing apparatus according to any one of paragraph 25 to 30, wherein the genuine information relates to the presence of a user at a location.

32. An information processing apparatus according to any one of paragraph 25 to 31 wherein the decoy information is selected from a store of genuine information associated with other users of different apparatuses.

33. An information processing apparatus according to paragraph 32, wherein the other users are demographically similar to the user of the first apparatus.

34. An information processing apparatus according to paragraph 32, wherein the other users are located in a similar geographical location to the user of the first apparatus.

35. An information processing apparatus according to any one of paragraph 32 to 34, wherein the genuine information is information relating to the health of the user of the first apparatus.

36. An information processing apparatus according to any one of paragraph 32 to 35, wherein the genuine information is information relating to the internet usage of the user of the first apparatus.

37. An information processing apparatus according to any one of paragraph 32 to 36, wherein the genuine information is information related to a journey being conducted by the user of the first apparatus.

38. An information processing apparatus according to paragraph 37, wherein the genuine information is route information or information relating to a characteristic of the vehicle in which the user is travelling.

39. An information processing apparatus according to any one of paragraph 25 to 38, wherein the genuine information is content information relating to the contents of a logistic container.

40. An information processing apparatus according to any one of paragraph 25 to 39, wherein the genuine information is information relating to a good in a shop.

41. An information processing apparatus according to paragraph 40, wherein the information is offer information.

42. An information processing apparatus according to any one of paragraph 25 to 41, wherein the information is communicated wirelessly between the first apparatus and the second apparatus.

43. An information processing apparatus according to any one of paragraph 25 to 42, wherein the decoy information is communicated to the second apparatus in place of the genuine information.

44. A second information processing apparatus, comprising:
communication circuitry configured to communicate with the first information processing apparatus of any one of paragraph 25 to 43; and control circuitry configured to:
receive the genuine information and the decoy information from the first apparatus;
identify the decoy information; and
act on the genuine information and isolate the decoy information.

45. A second information processing apparatus according to paragraph 44, wherein the genuine information and the decoy information are database addresses and the control circuitry is configured to access the database address to identify decoy information.

46. A second information processing apparatus according to paragraph 45, wherein the control circuitry is configured to provide authentication information to the database prior to accessing the database address, wherein in the event of a failed authentication, the control circuitry isolates the information.

47. A second information processing apparatus according to any one of paragraph 44 to 46, wherein the control circuitry is configured to ignore the decoy information.

48. A system comprising an information processing apparatus according to any one of paragraph 25 to 43 in communication with a second information processing apparatus according to any one of paragraph 44 to 47.

Further embodiments may include:

A method of obfuscating information communicated between a first apparatus and a second apparatus, comprising:
in the first apparatus,
   obtaining genuine information to be communicated to the second apparatus;
   obtaining decoy information to be communicated to the second apparatus, the decoy information being derived from genuine information;
   indicating the decoy information to be communicated to the second apparatus;
   transmitting the genuine information to the second apparatus; and
   periodically transmitting the decoy information to the second apparatus obfuscated within a temporal pattern of genuine information;
in the second apparatus,
   receiving the genuine information and the decoy information from the first apparatus;
   identifying the decoy information; and
   acting on the genuine information and isolating the decoy information.

The method above may be further refined wherein obtaining decoy information comprises selecting genuine information from a subset of genuine information, the subset being associated with attribute data and in the first apparatus identifying the subset using the attribute data.

A method of obfuscating information communicated between a first apparatus and a second apparatus, comprising:
in the first apparatus,
   obtaining genuine information to be communicated to the second apparatus;
   obtaining decoy information to be communicated to the second apparatus;
   indicating the decoy information to be communicated to the second apparatus;
   transmitting the genuine information to the second apparatus; and
   periodically transmitting the decoy information to the second apparatus, wherein the decoy information is selected from the genuine information and/or obtained decoy information based on the time of transmission of the decoy information and/or the location of the first apparatus;
in the second apparatus,
   receiving the genuine information and the decoy information from the first apparatus;
   identifying the decoy information; and
   acting on the genuine information and isolate the decoy information.

1. A method of obfuscating information communicated between a first apparatus and a second apparatus, comprising:
in the first apparatus,
obtaining genuine information to be communicated to the second apparatus;
obtaining decoy information to be communicated to the second apparatus;
indicating the decoy information to be communicated to the second apparatus;
transmitting the genuine information to the second apparatus; and
periodically transmitting the decoy information to the second apparatus, wherein the decoy information is selected based on the time of transmission of the decoy information and/or the location of the first apparatus;
in the second apparatus,
receiving the genuine information and the decoy information from the first apparatus;
identifying the decoy information; and
acting on the genuine information and isolate the decoy information.

2. A method according to claim 1, comprising, in the first apparatus, indicating the decoy information by application of a flag to the decoy information.

3. A method according to claim 1, wherein the genuine information and the decoy information are database addresses and, in the second apparatus, the identifying step comprises, accessing the database address to identify decoy information.

4. A method according to claim 3, comprising, in the second apparatus, providing authentication information to the database prior to accessing the database address, wherein in the event of a failed authentication, the second apparatus isolates the information.

5. A method according to claim 1, wherein the genuine information is mutually exclusive to the decoy information.

6. A method according to claim 1, wherein the decoy information at the time of transmission is selected from genuine information obtained at that same time on a different day.

7. A method according to claim 1, wherein the genuine information relates to a user of the first apparatus.

8. A method according to claim 7, wherein the genuine information relates to the presence of a user at a location.

9. A method according to claim 7, wherein the decoy information is selected from a store of genuine information associated with other users of different apparatuses.

10. A method according to claim 9, wherein the other users are demographically similar to the user of the first apparatus.

11. A method according to claim 9, wherein the other users are located in a similar geographical location to the user of the first apparatus.

12. A method according to claim 7, wherein the genuine information is information relating to the health of the user of the first apparatus.

13. A method according to claim 7, wherein the genuine information is information relating to the internet usage of the user of the first apparatus.

14. A method according to claim 7, wherein the genuine information is information related to a journey being conducted by the user of the first apparatus.

15. A method according to claim 14, wherein the genuine information is route information or information relating to a characteristic of the vehicle in which the user is travelling.

16. A method according to claim 1, wherein the genuine information is content information relating to the contents of a logistic container.

17. A method according to claim 1, wherein the genuine information is information relating to a good in a shop.

18. A method according to claim 17, wherein the information is offer information.

19. (canceled)

20. A method according to claim 1, wherein the decoy information is communicated to the second apparatus in place of the genuine information.

21. A method according to claim 1, wherein the decoy information is ignored within the second apparatus.

22. A method of receiving obfuscated information communicated from a first apparatus, comprising: receiving genuine information and, periodically, decoy information, wherein the decoy information is selected based on the time of transmission of the decoy information and/or the location of the first apparatus;
identifying the decoy information; and
acting on the genuine information and isolating the decoy information.

23. A method of transmitting obfuscated information to a second apparatus, comprising:
obtaining genuine information to be communicated to the second apparatus;
obtaining decoy information to be communicated to the second apparatus;
indicating the decoy information to be communicated to the second apparatus;
transmitting the genuine information to the second apparatus; and
periodically transmitting the decoy information to the second apparatus, wherein the decoy information is selected based on the time of transmission of the decoy information and/or the location of the first apparatus.

24. A non-transitory computer readable medium including a computer program product comprising computer readable instructions which, when loaded onto a computer, configures the computer to perform a method according to claim 1.

25. An information processing apparatus, comprising:
communication circuitry configured to communicate with a second information processing apparatus; and control circuitry configured to:
obtain genuine information to be communicated to the second information processing apparatus; obtain decoy information to be communicated to the second information processing apparatus; indicate the decoy information to be communicated to the second information processing apparatus;
transmit, via the communication circuitry, the genuine information to the second information processing apparatus; and
periodically transmit, via the communication circuitry, the decoy information to the second information processing apparatus, wherein the decoy information is selected based on the time of transmission of the decoy information and/or the location of the first apparatus.

26. An information processing apparatus according to claim 25, wherein the control circuitry is configured to indicate the decoy information by application of a flag to the decoy information.

27. An information processing apparatus according to claim 26, wherein the genuine information and the decoy information are database addresses.

28-29. (canceled)

30. An information processing apparatus according to claim 25, wherein the genuine information relates to a user of the first apparatus or presence of a user at a location.

31. (canceled)

32. An information processing apparatus according to claim 25 wherein the decoy information is selected from a store of genuine information associated with other users of different apparatuses.

33-48. (canceled)
